(19) United States
(12) Patent Application Publication
(10) Pub. No.: US 2018/0172227 A1
(43) Pub. Date: Jun. 21, 2018

(54) LUMINAIRES, SYSTEMS AND METHODS FOR PROVIDING SPECTRALLY AND SPATIALY MODULATED ILLUMINATION

(71) Applicant: Biological Innovation & Optimization Systems, LLC, Melbourne, FL (US)

(72) Inventors: Robert Soler, San Marcos, CA (US); Eric Thosteson, Satellite Beach, FL (US)

(73) Assignee: Biological Innovation & Optimization Systems, LLC, Kawasaki-shi (JP)

(21) Appl. No.: 15/833,023

(22) Filed: Dec. 6, 2017

Related U.S. Application Data
(60) Provisional application No. 62/450,893, filed on Jan. 26, 2017.
(60) Provisional application No. 62/450,887, filed on Jan. 26, 2017.
(60) Provisional application No. 62/434,618, filed on Dec. 15, 2016.
(60) Provisional application No. 62/543,227, filed on Aug. 9, 2017.
(60) Provisional application No. 62/583,393, filed on Nov. 8, 2017.

(51) Int. Cl. F21S 8/00; F21S 9/02; F21V 13/04; F21V 15/015; F21V 23/00; F21V 7/00

(52) U.S. Cl. CPC F21S 8/03; F21S 9/02; F21V 13/04; F21Y 2103/10; F21V 23/006; F21V 7/0008; F21V 7/0025; F21V 15/015

(57) ABSTRACT

Luminaries, fixtures, systems and methods of providing both spectrally and spatially targeted illumination are disclosed. Lighting fixtures including troffer type fixtures comprising LED packages with high melanopic flux and secondary optics for spatially directing or modulating illumination to facilitate or optimize biological effects of lighting are described. Also disclosed are human centric LED lighting fixtures and designs that are designed to coordinate with the time of day and human circadian rhythms. Luminaires that provide control and variation spectral output and that provide indirect spatially targeted lighting so as are also disclosed.

### RELATED APPLICATIONS

This application claims priority to and the benefit of U.S. Provisional Application No. 62/434,618, filed Dec. 15, 2016, U.S. Provisional Application No. 62/450,887, filed Jan. 26, 2017, U.S. Provisional Application No. 62/450,893, filed Jan. 26, 2017, U.S. Provisional Application No. 62/543,227, filed Aug. 9, 2017, and U.S. Provisional Application No. 62/583,393, filed Nov. 8, 2017. The contents of these applications are incorporated herein in their entirety.

Except to the extent that any of the disclosure in the referenced patents conflicts with the disclosure herein, the following US patents and publications, which include inter alia disclosure pertaining to light emitting diode (LED) luminaires, light distribution units, and tunable LED human centric lighting are incorporated herein by reference in their entireties: U.S. Pat. Nos. 9,788,387, 9,052,075, 8,905,575, 8,038,314, and 20130250567.

### FIELD OF THE INVENTION

Embodiments of the invention relate to lighting fixtures, systems and methods for providing spectrally and spatially adjustable high efficacy illumination and that may be used to optimally effect or coordinate with human circadian rhythms.

### BRIEF BACKGROUND

Light emitting diode (LED) technology is a maturing technology that continues to show improvements in efficiency, customability and cost reduction. LED technology is rapidly being deployed in a host of industries and markets including general lighting for homes, offices, and transportation, solid state display lighting such as in LCDs, aviation, agricultural, medical, and other fields of application. The increased energy efficiency of LED technology compared with other lighting solutions coupled with the reduction of costs of LED themselves are increasing the number of LED applications and rate of adoptions across industries. While LED technology promises greater reliability, longer lifetimes and greater efficiencies than other lighting technologies, the ability to mix and independently drive different color LEDs to produce customized and dynamic light output makes LED technology and solid state lighting (SSL) in general robust platforms to meet the demands of a variety of market needs and opens the door to many new applications of these lighting technologies. The ability to tailor and tune the output spectra of LED fixtures and dynamically switch individual LEDs “on-the-fly”, for example in response to an environmental cue, dramatically opens up the application space of solid state lighting.

As is well known in the art, LED luminaires generally comprise one or more individual LEDs dies or packages mounted on a circuit board. The LEDs may be electrically connected together on a single channel or be distributed and electrically driven across multiple independent channels. The LEDs are typically powered by current from an associated LED driver or power supply. Examples of these power supply drivers include AC/DC and DC/DC switched mode power supplies (SMPS). Examples of LED power drivers include power supplies designed to supply constant current to the LED string in order to maintain a consistent and steady light output from the LEDs. LEDs may also be powered by an AC power source. Direct AC power typically undergoes rectification and other power conditioning prior to being deliver to the LEDs. LED luminaires may also comprise an optic or diffuser, a heat sink and other structural components.

FIGS. 1a-b show perspective and end-view profiles of a conventional linear LED troffer replacement fixture 100. The well recognized and utilized troffer type fixture has wide applicability in providing lighting to a variety of environments. Such fixtures are generally mounted in or suspended from ceilings or other elevated positions within spaces and serve to illuminate the spaces below. Generally, LED linear lighting fixtures are widely available and comprise one or more light engines, associated driver circuitry, one or more power supplies, and reflective and/or and diffusive optics, power cable, etc. (not shown). The conventional LED troffer fixture 100 comprises LEDs 101 mounted on a board, a diffuser or other optic 103 for diffusing the light and reflector surfaces 105 for light distribution. Power supplies and other ancillary components are not shown. The troffer fixture design is effective in providing broad and uniform lighting in many environments.

Although LEDs may be combined in such a way to deliver a wide variety of specific color outputs, LED luminaires for general lighting typically are designed to produce white light. Light perceived as white or near-white may be generated by a combination of red, green, and blue (RGB) LEDs. Output color of such a device may be altered by color mixing, for instance varying the amount of illumination produced by each of the respective color LEDs by adjusting the supply of current to each of the red, green, and blue LEDs. Another method for generating white or near-white light is by using a lumiphor such as a phosphor in conjunction with a blue “pump” LED. Still another approach for producing white light is to stimulate phosphors or dyes of multiple colors with an LED source. Many other approaches can also be taken.

Melanopsin is a type of photopigment belonging to a larger family of light-sensitive retinal proteins called opsins, and is found in intrinsically photosensitive retinal ganglion cells (ipRGCs) of humans and other mammals. Melanopsin plays an important non-image-forming role in the photoentrainment of circadian rhythms as well as potentially many other physiologic functions. Stimulation of melanopsin-containing ipRGCs contributes to various reflexive responses of the brain and body to the presence of light. Melanopsin photoreceptors are sensitive to a range of wavelengths and reach peak light absorption at wavelengths around 480-500 (or 490) nanometers (nm). Melanopic light, that is light corresponding to the melanopsin action spectrum, including particularly the wavelengths in the 480-500 nm region is important for non-visual stimuli including physiological and neuroligcal effects such as pupillary light reflex and circadian entrainment and/or disruption. Time coordinated exposure, including over-exposure and under-exposure to melanopic light can be used to entrain and facilitate healthy circadian rhythms in humans and other mammals. When used herein, melanopic light is meant to generally refer to light that stimulates melanopsin and or that may have an effect on human circadian rhythms. When used herein, unless otherwise specified, “melanopic light” is not restricted to a particular or narrow band of wavelengths but rather is meant to mean light that corresponds to or is contained within range of wavelengths that correspond to the that melanopsin action spectrum.

Circadian related photoreceptors are in macular and peripheral vision nearest to the fovea. Melanopsin related photoreceptors are most sensitive in the lower hemisphere of the retina. Selective stimulation of these photoreceptors is possible by directing illumination, and specifically melanopic light, towards or away from the region of the retina where melanopic photoreceptors are most concentrated or most sensitive or responsive. If the desire is to optimally stimulate these photoreceptors, then a light source that produces high biological light (i.e., melanopic light) in this region would be a good solution. Equivalent Melanopic Lux (EML) is a metric for measuring the biological effects of light on humans. EML as a metric is weighted to the ipRGCs response to light and translates how much the spectrum of a light source stimulates ipRGCs and affects the circadian system. Melanopic ratio is the ratio of melanopic lux to photopic lux for a given light source.

The variation of the intensity of light output has a relatively straightforward and understandable effect, namely, higher or lower light intensities incident on the human visual system provide greater or lesser biological stimulation respectively (e.g., with respect to circadian rhythms), the combination of both color variation (e.g., via spectral tuning) and intensity variation can create complementary and in some cases synergistic biological effects. However, spatial distribution is a factor that adds a great deal of complexity and potential cost. Scientific studies have shown that light above the horizon has high biological significance compared with light coming from below the horizon. One consequence of this finding is that illumination emanating (e.g., reflecting) from vertical surfaces (e.g., upper portions of walls and ceilings) has a higher biological significance compared to lower horizontal surfaces (e.g., desktops and tabletops). This differential in biological effect is due at least in part to the fact that there is a greater concentration of melanopsin receptors (ipRGCs) in the lower hemisphere of the human retina than in the upper hemisphere. Specifics biological effects of light impacting the lower hemisphere of the retina may be greater than the biological effect of the same light incident on the upper hemisphere. Thus, optimizing biological effects of lighting may require the proper modulation of light and light distributions, not only in the spectral domain, but in the spatial domain as well. There is a need for lighting systems and methods that target and optimize biological effects by providing the appropriate lighting in both spatial and spectral domains. There is also a need to for lighting solutions that provide illumination that may be both spectrally and spatially modulated in order to target or optimize certain light sensitive biological effects. There is a need for lighting systems that create layers of light that illuminate different surfaces at different times of day (for example, high vertical illumination during biological daytime, and low vertical illumination during biological night time).

### BRIEF SUMMARY

Embodiments of the invention include a luminaire operable to deliver illuminations of varying spectral components over different spatial areas comprising a first LED operable to produce illumination of a first spectrum, a second LED operable to illuminate at a second spectrum, a diffuser, a reflector; and an optical divider comprising a first side and a second side, said optical divider positioned between said first LED and said second LED wherein said first LED is proximate to the first side of said optical divider and said second LED is proximate to the second side of said optical divider and wherein the first side of said divider reflects and redirects illumination from said first LED and the second side of said divider reflects and redirects illumination from said second LED.

Embodiments include such luminaires wherein the redirection of illumination from the first LED results in said first LED illumination being concentrated at higher angles relative to and away from the nadir of the luminaire and wherein the redirection of illumination from the second LED results in said second LED illumination being concentrated at lower angles relative to and towards the nadir of the luminaire. In some embodiments, first LED produces a daytime illumination spectrum rich in melanopic light, and the second LED produces a nighttime illumination spectrum depleted of melanopic light relative to that of the first LED. In some embodiments, the illumination produced by said first LED has a maximum spectral power density between 460 nm and 500 nm.

Some embodiments include luminaires comprising an electrical power driver for driving LEDs to illumination and a dimmer control circuit for selective dimming of the illuminations from each of said first and second LEDs. Some embodiments use dimmer control circuitry that operates based on input from a conventional 0-10 Volt dimmer to selectively dim the illumination of one or more of the LEDs. In some embodiments, the selective dimming of the luminaire via said dimming control circuit results in changes of both spectral intensity and spatial distribution of the illumination from the luminaire. Other embodiments of the include wireless communication means for controlling the spectral and spatial illumination output of the luminaire.

Embodiments of the invention include an LED luminaire operable to deliver illuminations of varying spectral components over different spatial areas and useful for facilitating circadian rhythm regulation comprising a first and second LED operable to produce illumination of a daytime spectrum; a third LED operable to illuminate at a nighttime spectrum; a diffuser or other transmissive optic; an electrical circuit for electrically driving the LEDs to illumination; a reflector wherein the reflector surface is part of the body of the luminaire and wherein the reflector reflects a portion of the illumination from at least one of said LEDs to illuminate a space beneath the luminaire; and a first and a second optical divider each comprising a first side and a second side and wherein said third LED is positioned proximate to and between the first and second optical dividers and wherein said first LED is positioned adjacent the first optical divider and the second LED is positioned adjacent the second optical divider, and wherein each of the sides of each optical divider facing said third LED reflects and redirects illumination from the third LED and the side of the first optical divider not reflecting illumination from the third LED reflects illumination from the first LED and the side of the second optical divider not reflecting illumination from the third LED reflects illumination from the second LED.

Additional embodiments include an LED luminaire that generates high efficacy white light and wherein one color of LEDs generate higher equivalent melanopic lux than the another color LED and wherein the luminaire generates both direct task lighting that is low in melanopic light and indirect lighting that is high in melanopic light. Other embodiments include a wherein selective dimming of the luminaire via said dimming control circuit results in changes of both spectral intensity and spatial distribution of the illumination from the luminaire. Some embodiments comprise wireless communication means for controlling the spectral and spatial illumination output of the luminaire. In some embodiments the redirection of illumination from the biologically effective daytime LEDs results in a daytime spectrum being concentrated at higher angles relative to and away from the nadir of the luminaire and wherein the redirection of illumination from the nighttime LED results in the nighttime spectrum being concentrated at lower angles relative to and towards the nadir of the luminaire.

Embodiments of the invention include an LED luminaire operable to deliver illuminations of varying spectral components over different spatial areas and useful for facilitating circadian rhythm regulation comprising a first LED package operable to produce and illumination spectrum with a peak maximum power density between 460 nm and 500 nm; a second LED package operable to produce an illumination spectrum with maximum power density not between 460 nm and 500 nm; electrical driving means for driving said first and second LED packages to illumination; dimming means for controlling independently controlling the illumination output of each of said first and second LED packages; and optical dividing means for spatially redirecting the illumination output of each of said first and second LED packages wherein the redirection from said optical divider means results in the illumination from the first LED package being concentrated at higher angles relative to and away from the nadir of the luminaire and the illumination from the second LED package being concentrated at lower angles relative to and towards the nadir of the luminaire.

Additional embodiments include a luminaire as described above further comprising wireless communication and control means for dimming the output of one or more of said LED packages and wherein said control means is automatic and coordinates relative illumination output with the time of day or other temporal signal. Other embodiments include luminaires wherein the optical divider means is configurable and wherein control means for adjusting the configuration of the optical divider means is included in the luminaire.

### BRIEF DESCRIPTION OF THE DRAWINGS

FIGS. 1a-b show a perspective view and end-view profile of a conventional linear LED troffer replacement fixture.

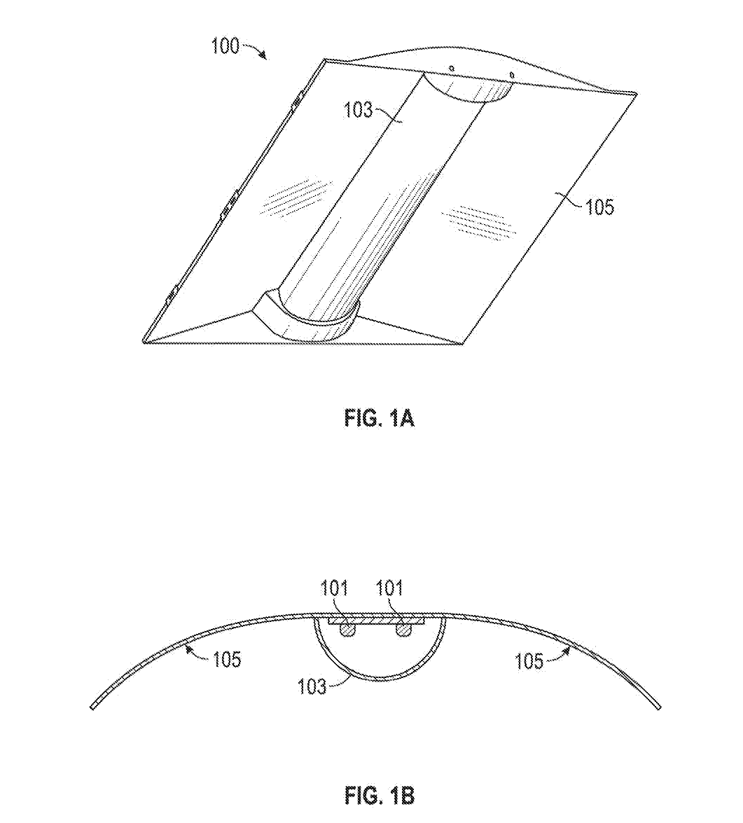

FIGS. 2a-c show perspective views and end-view profiles of the structure of a luminaire for providing spatially modulated illumination according to some embodiments.

FIGS. 3a-b show schematic end-view representations of a luminaire optical design and associated illumination projections and spatial distributions according to some embodiments.

FIGS. 4a-b show schematic end-view representations of a luminaire optical design and associated illumination projections and spatial distributions according to some embodiments.

FIG. 5 shows spatial distribution plots of illumination of a luminaire providing both high and low biological lighting according to some embodiments.

### DETAILED DESCRIPTION

Embodiments of the invention include methods, systems and luminaires that dynamically generate high efficacy white light that comprises enhanced spectral components that can vary in aspects of spectral and spatial distribution as well as intensity at different times of the day to facilitate circadian regulation or entrainment. Embodiments of the invention include dynamic illumination methods and systems for providing relatively high melanopic flux during the day and relatively low melanopic flux at night. Other embodiments of the invention include lighting systems which provide indirect illumination from the upper portions of the visual field of an observer wherein such illumination is enriched in melanopic light. In some embodiments, the exposure of melanopic light to photoreceptors in the lower hemisphere of the retina may be amplified or attenuated based on time of day in order to facilitate circadian rhythm regulation. Some embodiments include luminaires or lighting fixtures which provide both indirect lighting from the upper portions of visual fields rich in melanopic light and task lighting and indirect lighting from the lower portions of visual fields that are depleted in melanopic light. In some embodiments, the spectral, spatial and intensity variations may be coordinated with the local time or user preference to facilitate the coordination of human circadian rhythms or other biological effects.

Embodiments of the invention also include methods, luminaires and systems for providing biologically relevant light (e.g., melanopic light) from indirect illuminating sources and from sources which direct various spectral types of light in specific spatial directions and illuminate specific areas. When used herein, the term day-time LEDs may be used and is meant to refer to LEDs that produce illumination rich in melanopic light or which have a relatively high melanopic ratio and which generate relatively high equivalent melanopic lux. Similarly, the term night-time LEDs means LEDs that produce illumination that is relatively low or depleted of melanopic light or which have a relatively low melanopic ratio and which generate relatively low equivalent melanopic lux.

In some embodiments, the daytime light (rich in melanopic light) is projected onto the ceiling and upper portions of surrounding walls or partitions, and is reflected therefrom. This reflected indirect light from above may disproportionately impinge on the lower hemisphere of the retina of a conventionally oriented observer in the lighted space. This type of daytime light spatial distribution may be appropriate for optimal melanopic photoreceptor stimulation because the lower hemisphere of the retina is most sensitive to melanopic light relative to the upper hemisphere. Additionally, illumination from the night time LEDs is projected downward onto the task areas, e.g., a desk. During periods of the day when it would be inappropriate to receive melanopic light (for instance late in the day prior to bedtime), the nighttime LEDs will provide good illumination for task work, but will not be rich in melanopic light and therefore will have no or little impact or disruption the circadian rhythm of the individual(s) exposed to the illumination.

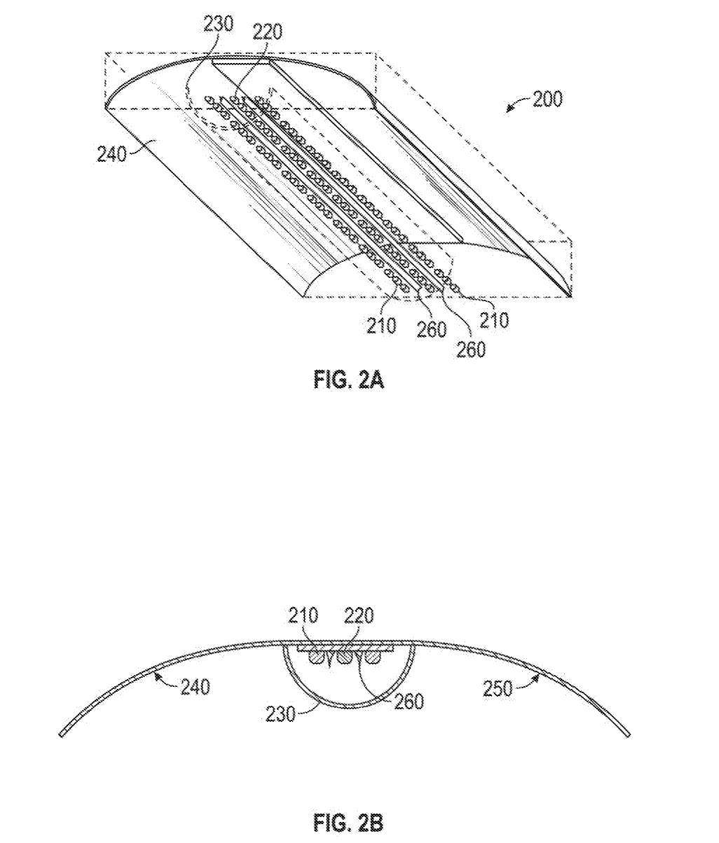

FIGS. 2.6 illustrate embodiments of the invention that include additional structural components for facilitating optical spatial distribution and/or spatial modulation of the illumination generated by both the daytime LEDs 210 and the nighttime LEDs 220. FIGS. 2-6 also illustrate schematically respective spatial projections and spatial distribution of the illumination generated by both the daytime LEDs 210 and the nighttime LEDs 220 and which employ dimming functionality according to some embodiments.

Some embodiments comprise a singular lighting fixture capable of modulating the spatial distribution of a fixture in an elegant fashion. FIGS. 2a-b show a perspective view and a schematic profile (e.g., end view) respectively of an LED fixture 200 according to some embodiments of the invention that includes daytime LEDs 210, nighttime LEDs 220, a diffuser 230, optical dividers 260 and tertiary reflectors 240 and 250. FIG. 2c illustrates a dose up view showing the details of the optical dividers 260 in proximity to both the daytime LEDs 210 and nighttime LED 220. According to some embodiments, the LED lighting fixture (also referred to herein as a luminaire) 200 includes two daytime LEDs 210, that provides light with relatively high biological effect, and a nighttime LED 220 that provides light with a relatively low biological effect. The fixture may comprise, and as shown in FIG. 2a both multiple daytime LEDs 210 and nighttime LEDs 220 arranged in a row fashion according to some embodiments. The lighting fixture 200 also includes a secondary optic 230, which may be a diffuser or lens. In some embodiments, the optic 230 receives the point source LED illuminations and mixes and “shapes” the point source illumination to provide even illumination in a desired spatial pattern. The light fixture 200 also includes and one or more tertiary reflectors 240 and 250, which take the combination of the primary optics (e.g., of the LED packages) and the secondary optics 230 and provides additional control to provide more illumination at high angles relative to nadir (that is, the point directly below the fixture). In operation and according to some embodiments, illumination from the LEDs 210 and 220 is reflected by optical dividers 260 and passes through the secondary optic/diffuser 230. Illumination, or a portion thereof, and is reflected by tertiary optics 240 and 250 to provide specific spatial and spectral light distributions. According to these embodiments, the illumination from the different color LEDs is mixed to provide a uniform white or near-white light and this mixed white light is directed and distributed to the space below via the tertiary reflective optics 240 and 250.

In some embodiments a switch or dimmer circuit (not shown) is utilized to adjust the intensity of either the daytime LED(s) 210, the nighttime LED(s) 220 or both. In some embodiments, the dimmer switch is a manual wall switch and operates to alter the current to either or both of the color LEDs 210 and 220. In other embodiments, the dimming functioning is accomplished via programmable circuitry integrated within the light fixture 200. In some embodiments the dimming, i.e., the adjustment of the relative intensities of the daytime LEDs 210 and/or the nighttime LEDs 220 is automatically done based on time of day or other preprogrammed protocol. For example, during parts of day when light of high biological stimulus would be beneficial to an occupant, the intensity of the daytime LEDs 210 may be high whereas during the evening, the intensity of the daytime LED 220 may be reduced or even eliminated to coordinate with the biology (for example, the circadian rhythms) of one or more occupants. This functionality is referred to as biological dimming.

FIG. 2b-c show schematic representations according to some embodiments of a luminaire design that includes additional optical components in order to generate spatial projections of illumination. An LED light fixture 200 operable to provide both spectral and spatial modulation, and according to some embodiments, includes an optical divider 260 configured and operable to deflect and direct the projection of light from high biological LEDs 210 and low biological LEDs 220 in specific directions. The optical divider 260 is situated between the daytime LEDs 210 and the nighttime LEDs 220 and serves to direct a greater amount of the illumination from the nighttime LEDs 220 downward, i.e., towards the area directly beneath the fixture. The optical divider 260 also serves to direct and a greater amount of the illumination from the daytime LEDs 210 outward, that is, the divider reduces the amount of illumination from the daytime LEDs 210 that impacts the area directly under the light fixture 220, and concomitantly increases the amount of illumination from the daytime LEDs 210 away from the nadir (the point directly below the light fixture 200). Thus, the optical divider 260 in conjunction with the daytime LEDs 210 and nighttime LEDs 220 allows for the spatial modulation and concentration of illumination of both the daytime LEDs and the nighttime LEDs. Although a specific shape, size and orientation of the optical dividers 260 is shown for illustration, embodiments of the invention are not limited to any specific shape, size or orientation. The optical dividers 260 may be of a variety of shapes and configurations, as will be evident to those skilled in the art, to accomplish the desired spatial and spectral modulation of the LED illumination disclosed herein.

With reference to the embodiments and disclosure herein, “high biological LEDs” means LEDs that produce light that have a relatively high biological effect versus “low biological LEDs” which have a comparatively low biological effect. For example, blue and/or blue-green light and LEDs that emit light in these wavelength regions typically have a higher biological effect than light or LEDs that emit light in the longer wavelength ranges. In some embodiments high biological LEDs mean LEDs that emit light with high melanopic flux, that is light that is rich in light of wavelengths between 460 and 520 nm (or between 480-500 nm or around 490 nm). Low biological LEDs means LEDs that emit much less (or none) melanopic light compared with the high biological LEDs. Light rich in melanopic flux (e.g., 490 nm) is known to have an effect on circadian rhythm entrainment. In some embodiments, high biological light and associated LEDs comprise light in the 400-460 nm range (or 420-450 nm), light that may provide an acute alerting affect to humans exposed to such light. When referred to herein “high “biological LEDs” may also be referred to as “daytime LEDs” and “low biological LEDs” may also be referred to as “nighttime LEDs”.

As described elsewhere herein, melanopic photoreceptors are more heavily concentrated in the lower hemisphere of the retina, and because light from above will more heavily impact the retinal lower hemisphere, such light may have a more significant impact on the biological system (e.g., circadian rhythms) if it is melanopic light. Conversely, if such light from above is depleted in melanopic light (e.g., nighttime LEDs), the biological effect would be minimal. In a variety of lighting applications including industrial, education, commercial environments, e.g., office spaces, hospital, factories, schools, and which are lighted with troffer fixtures such as described herein, much of the light received by an occupant “from above” will be reflected light. That is, illumination from a troffer light fixture 200 that exits outward of the light fixture (as opposed to downward) will generally impact the eye of an individual occupant with a level gaze such that it reaches the lower half of the retina. Additionally, much the outward directed illumination from the troffer light fixture 200 will reflect off of walls and similarly reach the an occupant indirectly and from above. Conversely, illumination from the light fixture 200 that is generally in the downward direction will reflect off the floor or task area and will impact the gaze of an occupant generally from below, and thereby more predominantly impact the upper half of the retina where melanopic receptors are in much lower concentration.

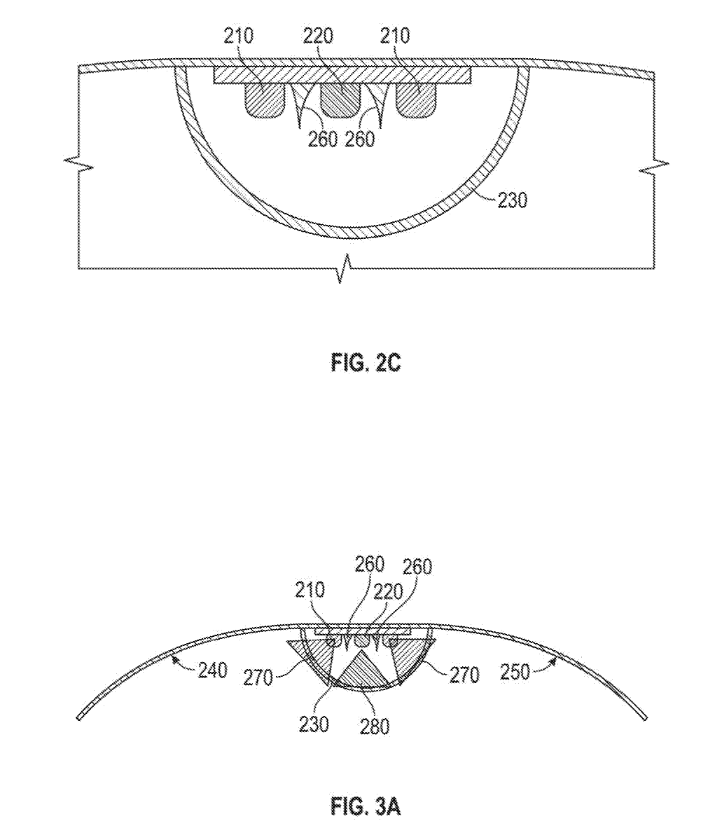

1 FIGS. 3a-b shows a schematic representation of the projections from both high biological LEDs 210 and low biological LEDs 220 onto specific portions of a secondary optic 230 and the general spatial illumination pattern of the respective daytime and nighttime LEDs, 210 and 220, according to some embodiments of luminaire design. The optical dividers 260 serve to deflect and spatially direct the illumination from each of daytime LEDs 210 and the nighttime LEDs 220 to different sections of the secondary reflective optic 230 as shown. High biological light projections 270 (from the daytime LEDs 210) and low biological light projection 280 (from the nighttime LEDs 220) on the secondary optic 230 are shown and represent schematically the spatially redirected light due to the optical dividers 260. The spatial projections of the daytime LEDs 210 and nighttime LEDs 230 onto optic 230 are shown as 270 and 280 respectively.

FIG. 3b shows schematically, the light pattern resulting from a combination of the high biological light projections 270 and the low biological light projections 280 described in FIG. 3a. In this embodiment, both the daytime LEDs 210 and nighttime LEDs 220 are illuminated at normal power, that is neither color LED is dimmed. The illumination pattern according to this embodiment is shown schematically; the luminance from the daytime LEDs 210 is generally projected outward (at higher angles from nadir) as shown by arrows 310, and the luminance from the nighttime LEDs 220 is generally projected downward as shown by arrows 320. These light outputs applied together illustrate embodiments of the light fixture 200 configured to the “high” setting on a typical commercial off the shelf 0-10 volt dimmer and according to some embodiments.

According to some embodiments, a dimmer circuit allows for the lighting device to be altered to relatively high biological effect light, relatively low biological effective light or points in between, via the adjustment of a dimmer switch (e.g., wall switch). In these embodiments a standard dimmer control (not shown), or other means current for altering or adjusting the power delivered to each of the daytime LEDs 210 and the nighttime LEDs 220 is used to adjust the illumination output of each type of LEDs. In some embodiments, a single dimmer control is used to intensity of illumination of the daytime LEDs only. In some embodiments, a single control is used to adjust both color LEDs together and simultaneously. In still other embodiments, separate dimmer controls for each color LEDs are used.

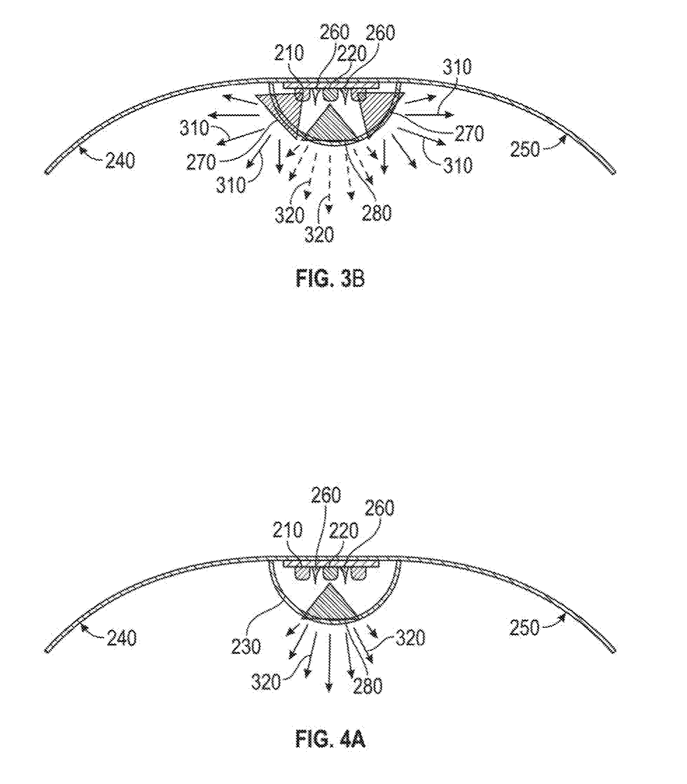

FIGS. 4a-b show light patterns resulting from the light projections, as described in FIG. 3, according to some embodiments wherein selective dimming is employed. In some embodiments dimmers, for example a standard 0-10 Volt dimmer controls, are used to regulate the amount of illumination from each of the daytime LEDs 210 and the nighttime LEDs 220.

FIG. 4a shows light pattern 320 resulting from low biological light projections 280 according to some embodiments. In this embodiment, dimming functionality as been used to dim the daytime LED 210 such that the only illumination is from the nighttime LEDs 220. This light pattern illustrates an embodiment of the luminaire 200 configured to the “low” setting on a typical commercial off the shelf 0-10 volt dimmer. Other embodiments include partial dimming of the daytime LEDs 220 such that they illuminate with reduced power. Other embodiments include using different dimming methodologies including wireless control.

FIG. 4b shows light pattern 310 resulting from high biological light projections 270 according to some embodiments. In this embodiment, dimming functionality as been used to dim the nighttime LED 220 such that the only illumination is from the daytime LEDs 210. This light pattern illustrates an embodiment of the luminaire 200 configured to the “medium” setting on a typical commercial off the shelf 0-10 volt dimmer. Other embodiments include partial dimming of the nighttime LEDs 130 such that they illuminate with reduced power.

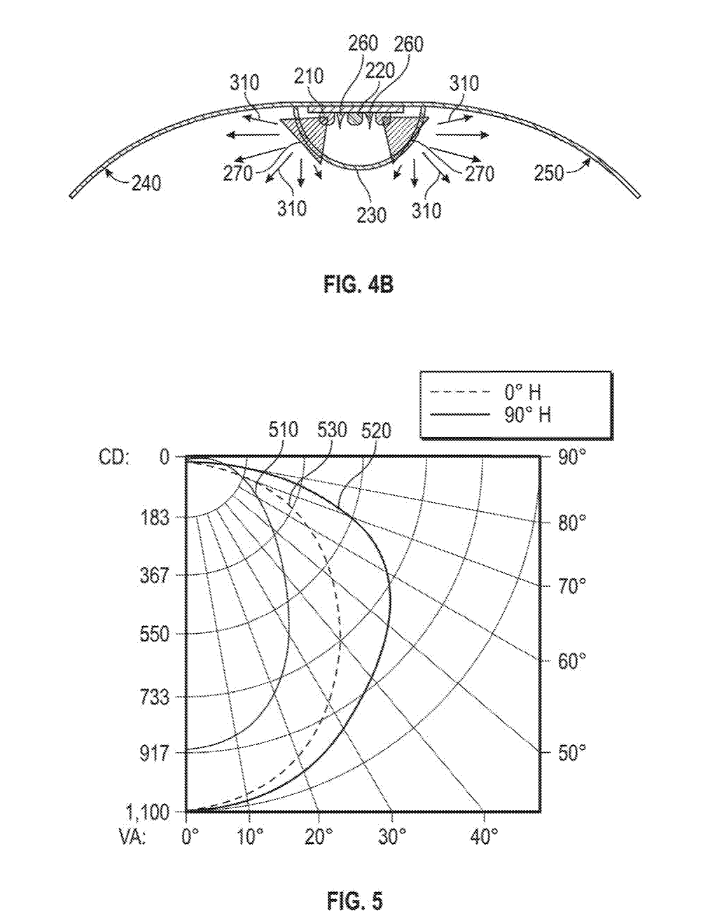

FIG. 5 shows a polar plot of the radiation pattern of the lighting fixture 200 according to some embodiments. The resultant spatial distribution of illumination from the light fixture 200 may be varied via dimming circuitry as described elsewhere herein. Radiation pattern 510 results when the dimmer setting is “low”, i.e., nighttime LEDs only, and radiation pattern 520 results when the dimmer is set to high, i.e., both daytime and nighttime LEDs are illuminated, according to these embodiments. As will be evident to those skilled in the art, a variety of dimming schemes may be employed to accomplish one or more specific spatial and spectral outputs and these schemes may be varied automatically, e.g., based on time of day, the occupants schedules, etc. FIG. 5 represents specific radiation patterns according to some embodiments. As will be evident to those skilled in the art, a variety of radiation patterns of daytime LEDs 210, nighttime LEDs 220, and the luminaire itself 200 may be achieved using dimming functionality and/or spatial configuration and orientation of the physical components of the luminaire 200, i.e., positioning and shape of optical dividers 260, tertiary reflectors design, etc.

In some embodiments when the luminaire 200 is dimmed, dimming of the LEDs occurs sequentially with the daytime LEDs 220 located on the outside optical dividers 260 being dimmed first, and the nighttime LEDs 220 located on the inside dividers 260 dimmed last. In these embodiments, the total spatial distribution of the fixture would be wider when configured to “high” setting from a typical commercial off the shelf 0-10 volt dimmer, providing higher vertical illumination. When the fixture is configured to have mid dimmer settings, the low biological LEDs 220 will remain fully illuminated, while the high biological LEDs 210 will have significantly lower brightness. When fixture is configured to “low” setting from 0-10 volt dimmer, significantly higher illumination will come from the low biological LEDs 220 compared to the illumination from the high biological LEDs 210.

In some embodiments, a 0-10 volt dimmer (or other dimmer circuit/means) signal is directed to effecting the spatial output component, and another 0-10 volt dimmer signal is directed to effecting the spectral stimulation, and another 0-10 volt dimmer signal is directed to the visual brightness (lumens) coming from the fixture. In other embodiments, these signals are combined in order to simplify controls. In some embodiments, the dimming or other control signal may be something other than 0-10 volt dimmer signal. For example other wired protocols such as DALI (Digital Addressable Lighting Interface) or BACNET may be used, as well as other wireless protocols such as Zigbee or Bluetooth as will be evident to those skilled in the art.

Additional embodiments of the invention include fixtures or light engines and dimming circuits or other control means wherein the spectral power distributions of the high biological LEDs 210 and low biological LEDs 220 are not varied, and the biological impact from the spatial modulation of illumination is used reduce the complexity of the total fixture. In these embodiments, controlling and/or modulating the spatial distribution of the light accomplishes the desired biological effect. According to some of these embodiments, simplicity and the absence of a dimming circuit may appeal to many designers and be cost effective as it allows for, inter alia, a simple LED board and driver circuit for effecting biologically optimum illumination.

While the invention has been described with reference to exemplary embodiments, it will be understood by those skilled in the art that various changes may be made and equivalents may be substituted for elements thereof without departing from the scope of the invention. It should be understood that the diagrams herein illustrates some of the system components and connections between them and does not reflect specific structural relationships between components, and is not intended to illustrate every element of the overall system, but to provide illustration of the embodiment of the invention to those skilled in the art. Moreover, the illustration of a specific number of elements, such as LED drivers power supplies or LED fixtures is in no way limiting and the inventive concepts shown may be applied to a single LED driver or as many as desired as will be evident to one skilled in the art.

In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include many variants and embodiments. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A luminaire operable to deliver illuminations of varying spectral components over different spatial areas comprising:
a first LED operable to produce illumination of a first spectrum;
a second LED operable to illuminate at a second spectrum;
a diffuser;
a reflector; and
an optical divider comprising a first side and a second side, said optical divider positioned between said first LED and said second LED wherein said first LED is proximate to the first side of said optical divider and said second LED is proximate to the second side of said optical divider and wherein the first side of said divider reflects and redirects illumination from said first LED and the second side of said divider reflects and redirects illumination from said second LED.

2. The luminaire of claim 1 wherein the redirection of illumination from the first LED results in said first LED illumination being concentrated at higher angles relative to and away from the nadir of the luminaire and wherein the redirection of illumination from the second LED results in said second LED illumination being concentrated at lower angles relative to and towards the nadir of the luminaire.

3. The luminaire of claim 1 wherein said first LED produces a daytime illumination spectrum rich in melanopic light.

4. The luminaire of claim 3 wherein said second LED produces a nighttime illumination spectrum depleted of melanopic light relative to that of the first LED.

5. The luminaire of claim 3 wherein the illumination produced by said first LED has a maximum spectral power density between 460 nm and 500 nm.

6. The luminaire of claim 1 further comprising an electrical power driver for driving said LEDs to illumination and a dimmer control circuit for selective dimming of the illuminations from each of said first and second LEDs.

7. The luminaire of claim 6 wherein said dimmer control circuit operates based on input from a conventional 0-10 Volt dimmer to selectively dim the illumination of at least one of said first and second LEDs.

8. The luminaire of claim 6 wherein selective dimming of the luminaire via said dimming control circuit results in changes of both spectral intensity and spatial distribution of the illumination from the luminaire.

9. The luminaire of claim 1 further comprising wireless communication means for controlling the spectral and spatial illumination output of the luminaire.

10. An LED luminaire operable to deliver illuminations of varying spectral components over different spatial areas and useful for facilitating circadian rhythm regulation comprising:
a first and second LED operable to produce illumination of a daytime spectrum;
a third LED operable to illuminate at a nighttime spectrum;
a diffuser or other transmissive optic;
an electrical circuit for electrically driving the LEDs to illumination;
a reflector wherein the reflector surface is part of the body of the luminaire and wherein the reflector reflects a portion of the illumination from at least one of said LEDs to illuminate a space beneath the luminaire; and
a first and a second optical divider each comprising a first side and a second side and wherein said third LED is positioned proximate to and between the first and second optical dividers and wherein said first LED is positioned adjacent the first optical divider and the second LED is positioned adjacent the second optical divider, and wherein each of the sides of each optical divider facing said third LED reflects and redirects illumination from the third LED and the side of the first optical divider not reflecting illumination from the third LED reflects illumination from the first LED and the side of the second optical divider not reflecting illumination from the third LED reflects illumination from the second LED.

11. The LED luminaire of claim 10 further comprising a dimmer control circuit for selectively adjusting the illumination output of the LEDs.

12. The LED luminaire of claim 10 wherein the daytime spectrum comprises illumination rich in melanopic light and the nighttime illumination spectrum comprises illumination depleted of melanopic light.

13. The LED luminaire of claim 10 wherein the luminaire generates high efficacy white light and the first and second LEDs each generate higher equivalent melanopic lux than the third LED.

14. The luminaire of claim 10 wherein the luminaire generates direct task lighting that is low in melanopic light and generates indirect lighting that is high in melanopic light.

15. The luminaire of claim 11 wherein selective dimming of the luminaire via said dimming control circuit results in changes of both spectral intensity and spatial distribution of the illumination from the luminaire.

16. The luminaire of claim 11 further comprising wireless communication means for controlling the spectral and spatial illumination output of the luminaire.

17. The luminaire of claim 10 and wherein the redirection of illumination from the first and second LED results in the daytime spectrum being concentrated at higher angles relative to and away from the nadir of the luminaire and wherein the redirection of illumination from the third LED results in the nighttime spectrum being concentrated at lower angles relative to and towards the nadir of the luminaire.

18. An LED luminaire operable to deliver illuminations of varying spectral components over different spatial areas and useful for facilitating circadian rhythm regulation comprising:
a first LED package operable to produce and illumination spectrum with a peak maximum power density between 460 nm and 500 nm;
a second LED package operable to produce an illumination spectrum with maximum power density not between 460 nm and 500 nm;
electrical driving means for driving said first and second LED packages to illumination;
dimming means for controlling independently controlling the illumination output of each of said first and second LED packages; and
optical dividing means for spatially redirecting the illumination output of each of said first and second LED packages wherein the redirection from said optical divider means results in the illumination from the first LED package being concentrated at higher angles relative to and away from the nadir of the luminaire and the illumination from the second LED package being concentrated at lower angles relative to and towards the nadir of the luminaire.

19. The LED luminaire of claim 18 further comprising wireless communication and control means for dimming the output of one or more of said LED packages and wherein said control means is automatic and coordinates relative illumination output with the time of day or other temporal signal.

20. The LED luminaire of claim 18 wherein said optical divider means is configurable and further comprising control means for adjusting the configuration of said optical divider.
